(19) United States
(12) Patent Application Publication
(10) Pub. No.: US 2008/0203754 A1
(43) Pub. Date: Aug. 28, 2008

(54) AUTOMOTIVE RIM INSTRUMENT PANEL SKIN WITH INTEGRATED WINDSHIELD CLOSEOUT

(76) Inventors: Stephen A. Towne, Highland, MI (US); Gregg S. Evans, Windsor (CA)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/034,230

(22) Filed: Feb. 20, 2008

Related U.S. Application Data
(60) Provisional application No. 60/890,908, filed on Feb. 21, 2007.

(51) Int. Cl. B60J 10/02

(52) U.S. Cl. 296/93

(57) ABSTRACT

A windshield closeout system including an instrument panel having a reaction injection molded skin layer, and a closeout component including a resiliently biased closeout section extending from and integrally formed with the skin layer. The closeout section may be biased upwards in a predetermined direction for contiguous engagement with a windshield upon installation of the instrument panel relative to the windshield.

### RELATED APPLICATIONS

This application claims benefit of priority of Provisional Application Ser. No. 60/890,908 filed Feb. 21, 2007, hereby incorporated by reference in its entirety.

### BACKGROUND OF INVENTION

a. Field of Invention

The invention relates generally to the manufacture of automotive instrument panels, windshields and associated components, and, more particularly, to an apparatus for and method of manufacturing an integrated windshield closeout.

b. Description of Related Art

Automotive interior components are often produced in a variety of specifications based on the quality and fit expected by customers, and based on the operational requirements for such components. For automotive windshields and related components, any undesirable gap between associated components can result in problems such as vibration between the components, contamination of the gap area, undesirable passage of air and/or noise into the vehicle passenger compartment.

In order to address the aforementioned exemplary requirements associated with automotive windshield and related components, referring to FIGS. 1A, 1B, 2A and 2B, windshields are generally provided with an extruded closeout component 10 or 12 disposed between windshield 14 and instrument panel 16. Extruded closeout component 10 includes a deformable circular member 18 having a clip-type connection 20 engageable with edge 22 of instrument panel 16. Instrument panel 16 includes a typical construction having a skin layer 24, a foam layer 26 and a substrate layer 28. As shown in FIGS. 1A and 1B, extruded closeout component 10 may be attached to instrument panel 16 as shown for closing gap 30 between windshield 14 and instrument panel 16.

Referring to FIGS. 2A and 2B, in a similar manner as FIGS. 1A and 1B, extruded closeout component 12 includes a deflectable member 32 having a clip-type connection 34 engageable with edge 22 of instrument panel 16. As discussed above, instrument panel 16 includes a typical construction having a skin layer 24, a foam layer 26 and a substrate layer 28. As shown in FIGS. 2A and 2B, extruded closeout component 12 may be attached to instrument panel 16 as shown for closing gap 30 between windshield 14 and instrument panel 16.

While extruded closeout components 10, 12 described above provide adequate sealing and closeout of the area between windshield 14 and instrument panel 16, as readily evident, separate steps are required for the manufacture of components 10, 12, as well for assembly thereof. In an automotive production environment in which elimination of a single manufacturing or production step can be of significant importance both from cost, efficiency and production perspectives, elimination of the separate manufacturing and attachment requirement for components 10, 12 is desirable.

It would therefore be of benefit to provide a method of manufacturing automotive instrument panels and their related components to include a windshield closeout that eliminates the requirements for separate manufacture and attachment of the closeout components. It would also be of benefit to provide a method of manufacturing automotive instrument panels and their related components which is robust in design, and which provides the same or improved closeout performance compared to conventional windshield closeout methods.

### SUMMARY OF INVENTION

The invention overcomes the drawbacks and deficiencies of prior art automotive instrument panel and related component designs by providing a windshield closeout system including an instrument panel having a reaction injection molded skin layer, and a closeout component including a resiliently biased closeout section extending from and integrally formed with the skin layer. The closeout section may be biased upwards in a predetermined direction for contiguous engagement with a windshield upon installation of the instrument panel relative to the windshield.

For the windshield closeout system described above, the instrument panel may include a foam layer sandwiched between the skin layer and a substrate layer. The closeout component may be manufactured with the skin layer.

The invention also provides a windshield closeout system including an instrument panel including a skin layer, and a closeout component including a resiliently biased closeout section extending from and integrally formed with the skin layer. The closeout section may be contiguously engageable with a windshield upon installation of the instrument panel relative to the windshield.

For the windshield closeout system described above, the instrument panel may include a foam layer sandwiched between the skin layer and a substrate layer. The closeout component may be manufactured with the skin layer. In a particular embodiment, the instrument panel may be reaction injection molded. Further, in a particular embodiment, the closeout section may be biased upwards.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1A is an illustrative view of a related-art windshield closeout seal, and FIG. 1B is an enlarged view thereof;

FIG. 2A is an illustrative view of another related-art windshield closeout seal, and FIG. 2B is an enlarged view thereof; and

FIG. 3A is an illustrative view of an integrated windshield closeout seal according to the present invention, and FIG. 3B is an enlarged view thereof.

### DETAILED DESCRIPTION OF THE PREFERRED EMBODIMENTS

Referring now to the drawings wherein like reference numerals designate corresponding parts throughout the several views, FIGS. 3A and 3B illustrate an integrated windshield closeout seal according to the present invention, generally designated “windshield closeout system 40.”

Referring to FIGS. 3A and 3B, windshield closeout system 40 may generally include an instrument panel 42 including a skin layer 44 being manufactured by reaction injection molding (RIM), a substrate layer 46 and a foam layer 48 sandwiched between layers 44, 46.

The RIM process for molding plastic parts generally uses liquid monomers (i.e. polyurethanes or foamed polyurethanes) by pumping the monomers into a mix head where they are combined under high pressure with isocynanate. During this process, the mixture fills the mold cavity under low pressure, and the monomers are polymerized into a solid mass by energy supplied by a chemical reaction. RIM thus allows for the production of parts with intricate detail, dimensional stability, and wear resistance, and allows for flowability for the encapsulation of a variety of inserts.

Referring again to FIGS. 3A and 3B, windshield closeout system 40 may further include a closeout component 50 which includes a resilient section 52 extending from the RIM molded skin layer 44. As shown in FIG. 3B, resilient section 52 may be biased upwards as shown so that when section 52 is wedged against windshield 54, section 52 deflects downwards to contiguously engage windshield 54 for closing gap 56.

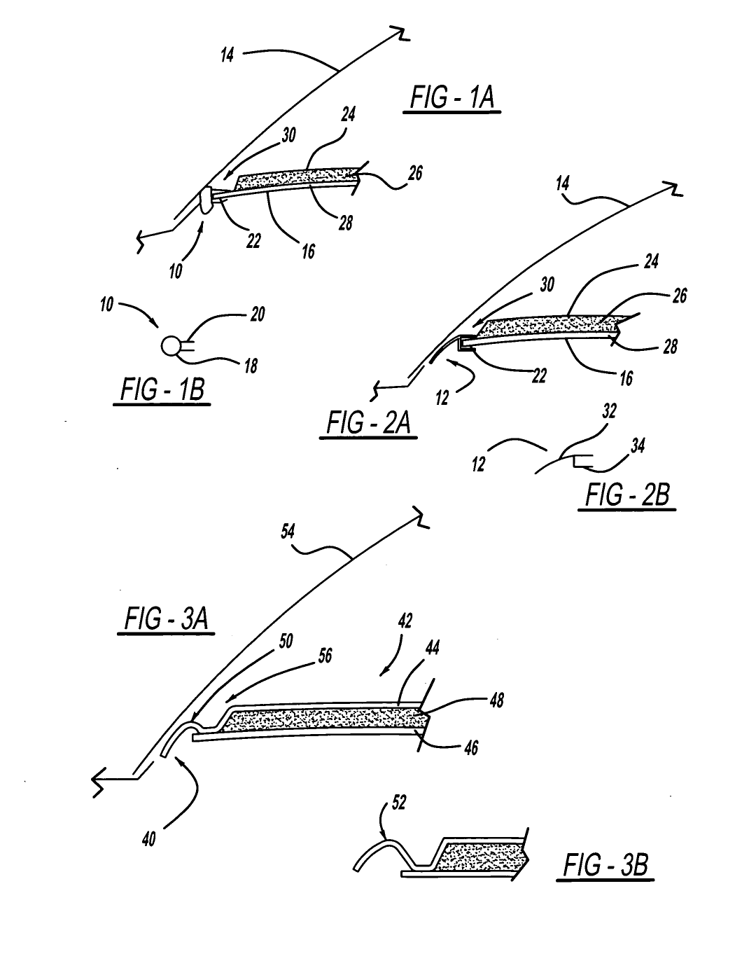

In this manner, compared to the related art closeout systems of FIGS. 1A-2B, windshield closeout system 40 eliminates the requirements for separate manufacture and attachment of the closeout components. The implementation of windshield closeout system 40 also provides a method of manufacturing automotive instrument panels and their related components with the same or improved closeout performance compared to conventional windshield closeout methods.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A windshield closeout system comprising:
an instrument panel including a reaction injection molded skin layer; and
a closeout component including a resiliently biased closeout section extending from and integrally formed with said skin layer,
wherein said closeout section being biased upwards in a predetermined direction for contiguous engagement with a windshield upon installation of the instrument panel relative to the windshield.

2. A windshield closeout system according to claim 1, wherein the instrument panel includes a foam layer sandwiched between said skin layer and a substrate layer.

3. A windshield closeout system according to claim 1, wherein said closeout component is manufactured with said skin layer.

4. A windshield closeout system comprising:
an instrument panel including a skin layer; and
a closeout component including a resiliently biased closeout section extending from and integrally formed with said skin layer,
wherein said closeout section being contiguously engageable with a windshield upon installation of the instrument panel relative to the windshield.

5. A windshield closeout system according to claim 4, wherein the instrument panel includes a foam layer sandwiched between said skin layer and a substrate layer.

6. A windshield closeout system according to claim 4, wherein said closeout component is manufactured with said skin layer.

7. A windshield closeout system according to claim 4, wherein said instrument panel is reaction injection molded.

8. A windshield closeout system according to claim 4, wherein said closeout section is biased upwards.
